(19) United States
(12) Patent Application Publication
(10) Pub. No.: US 2012/0244440 A1
(43) Pub. Date: Sep. 27, 2012

(54) RECHARGEABLE LITHIUM BATTERY

(76) Inventors: Nathan Lee, Yongin-si (KR); Ung-Kuk Heo, Yongin-si (KR); Seung-Ho Na, Yongin-si (KR)

(21) Appl. No.: 13/363,286

(22) Filed: Jan. 31, 2012

(30) Foreign Application Priority Data
Mar. 24, 2011 (KR) 10-2011-0026578
Oct. 5, 2011 (KR) 10-2011-0101285

(51) Int. Cl. H01M 4/62; H01M 4/131; H01M 4/134

(52) U.S. Cl. 429/217; 429/218.1; 429/221; 429/223; 429/224; 429/231.5; 429/231.95; 429/231.6

(57) ABSTRACT

A rechargeable lithium battery, which includes: a negative electrode including a silicon-based negative active material; a positive electrode (including a positive active material capable of intercalating and deintercalating lithium, and a conductive material including a fiber shaped material and a non-fiber shaped material), wherein a weight per unit area of the positive electrode (which is a loading level (LL) of the positive electrode) is about 20 mg/cm² to 100 mg/cm²; and a non-aqueous electrolyte.

### CROSS-REFERENCE TO RELATED APPLICATION

This application claims priority to and the benefit of Korean Patent Application No. 10-2011-0026578, filed in the Korean Intellectual Property Office on Mar. 24, 2011, and Korean Patent Application No. 10-2011-0101285, filed in the Korean Intellectual Property Office on Oct. 5, 2011, the entire contents of all of which are incorporated herein by reference.

### BACKGROUND

1. Field

The following description is related to a rechargeable lithium battery.

2. Description of the Related Art

A carbon-based material is generally used as a negative active material for a rechargeable lithium battery, but the use of the carbon-based material has a limitation in that the carbon-based material has limited capacity.

Recently, researchers are studying to develop other negative electrode materials for replacing the carbon-based material as the demand for high-capacity increases. Among the negative electrode materials is metal lithium, which has high energy density, but after repeated charges/discharges, has a problem of stability and shortening cycle-life due to the growth of dendrite.

Also, there are many studies showing lithium alloy as a material that can provide for high-capacity and is capable of substituting metal lithium. Silicon (Si) is capable of reacting with lithium and its theoretic maximum capacity is 4000 mAh/g, which is greater than the carbon-based material. Therefore, it is quite useful as a substitute for the carbon-based material.

In the case of silicon, however, cracks may occur as a result of a volumetric change, and Si active material particles are destroyed during a charge/discharge. Therefore, as charge and discharge cycles go on, the capacity is drastically decreased, and the cycle-life characteristic is deteriorated.

There have been efforts for overcoming the problem of deteriorated cycle-life caused by mechanical degradation through diverse methods.

Many of them are in the form of research for overcoming the typical problem of deteriorated cycle-life through the use of a composite active material formed of a material not reacting with a material that reacts with lithium. Particularly, a nano grain composite of Si/SiO₂, which is an SiO material, shows an excellent cycle-life characteristic, compared with conventional Si-based alloy and composite. The SiO material is envisioned to be an excellent negative active material from this perspective.

However, when the material is applied as a negative active material for high capacity, there is a problem of increasing the loading level of a positive electrode plate to meet the charge amount of a positive electrode.

When the loading level is increased, the conductivity of an electrode plate is decreased to cause an increase in resistance, which leads to a decreased high rate characteristic (e.g., high rate discharge characteristic) of a battery.

### SUMMARY

An aspect of an embodiment of the present invention is directed toward a rechargeable lithium battery including a negative active material with improved cycle-life characteristic.

An aspect of an embodiment of the present invention is directed toward a rechargeable lithium battery including a negative active material with improved cycle-life characteristic, and a positive electrode having high-capacity and excellent conductivity.

An embodiment of the present invention provides a rechargeable lithium battery, including: a negative electrode including a silicon-based negative active material; a positive electrode including a positive active material capable of intercalating and deintercalating lithium, and a conductive material including a fiber shaped material and a non-fiber shaped material, wherein a weight per unit area (which is a loading level (LL) of the positive electrode) is about 20 mg/cm² to 100 mg/cm²; and a non-aqueous electrolyte.

The plate density of the positive electrode, which is a weight per unit volume of the positive electrode, may be about 3.0 g/cc to about 4.1 g/cc.

The conductive material may include the non-fiber shaped material and the fiber shaped material at a weight ratio of about 0.6 to about 3.

The weight ratio of the positive active material and the conductive material may range from about 97:3 to 99:1.

The positive electrode may be a positive electrode plate including a current collector and a layer including the positive active material and the conductive material over the current collector.

The layer including the positive active material and the conductive material may further include a binder.

The binder may be at least one selected from polyvinylalcohol, carboxylmethylcellulose, hydroxypropylcellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon.

The total thickness of the positive electrode may be about 10 μm to about 300 μm.

The diameter of the fiber shaped material may be about 0.01 an to about 100 μm, and the length may be about 1 an to about 100 μl.

The fiber shaped material may include at least one selected from the group consisting of a vapor grown carbon fiber (VGCF), a carbon nano-tube, a carbon nano-fiber, and a metal fiber.

The non-fiber shaped material may include at least one selected from the group consisting of natural graphite, artificial graphite, carbon black, acetylene black, ketjen black, copper, nickel, aluminum, silver, and polyphenylene.

The non-fiber shaped material may include at least one shape selected from the group consisting of plate shape, bead shape, and flake shape.

The silicon-based negative active material may include at least one selected from the group consisting of silicon (Si), silicon oxide, silicon oxide coated with conductive carbon, and silicon (Si) coated with conductive carbon.

The positive active material may include one selected from LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5 and 0≦c≦0.05); LiₐNi_{1-b-c}Co_{b}R_{c}D_{α} (wherein, in the above formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above formula, 0.90≦a≦1.8, 0≦b≦0.5, 0≦c≦0.05 and 0≦a≦2); LiₐNi_{1-b-c}Mn_{b}R_{c}D_{α} (wherein, in the above formula, 0.90≦a≦1.8, 0≦b≦0.5, 0≦c≦0.05 and 0≦a≦2); LiₐNi_{1-b-c}Co_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃(0≦f≦2); Li_{(3-f)}Fe₂(PO₄)₃ (0≦f≦2); LiFePO₄, and a combination thereof, wherein

A is selected from Ni, Co, Mn, and combinations thereof; R is selected from Al, Ni, Co, Mn, Cr, Fe, Mg, Sr, V, rare earth elements, and combinations thereof; D is selected from O, F, S, P, and combinations thereof; E is selected from Co, Mn, and combinations thereof; Z is selected from F, S, P, and combinations thereof; G is selected from Al, Cr, Mn, Fe, Mg, La, Ce, Sr, V, and combinations thereof; Q is selected from Ti, Mo, Mn, and combinations thereof; T is selected from Cr, V, Fe, Sc, Y, and combinations thereof; and J is selected from V, Cr, Mn, Co, Ni, Cu and combinations thereof.

The positive electrode may include an Al current collector.

The cycle-life characteristic of the rechargeable lithium battery is improved using a silicon-based negative active material, and the loading level is increased while maintaining excellent conductivity by forming a thick positive electrode.

### BRIEF DESCRIPTION OF THE DRAWINGS

FIG. 1 is a cross-sectional view illustrating a positive electrode including a fiber shaped material and a non-fiber shaped material as conductive materials in a rechargeable lithium battery in accordance with an embodiment of the present invention.

FIG. 2 is an exploded perspective view of a rechargeable lithium battery in accordance with an embodiment of the present invention.

### DETAILED DESCRIPTION

Embodiments of the present invention will be described more fully hereinafter with reference to the accompanying drawings, in which exemplary embodiments of the invention are shown.

One embodiment of the present invention provides a rechargeable lithium battery, including: a negative electrode including a silicon-based negative active material; a positive electrode (including a current collector, a positive active material capable of intercalating and deintercalating lithium, and a conductive material including a fiber shaped material and a non-fiber shaped material), wherein a weight per unit area (which is a loading level (LL) of the positive electrode) is about 20 mg/cm² to 100 mg/cm²; and a non-aqueous electrolyte. The loading level (LL) of the positive electrode is measured excluding the weight (amount) of the current collector (e.g., including the weight of the positive active material and the weight of the conductive material, but not the weight of the current collector).

Another embodiment of the present invention provides a rechargeable lithium battery in which a plate density of the positive electrode, which is a weight per unit volume of the positive electrode, is about 3.0 g/cc to about 4.1 g/cc in order to realize a high-capacity cell. The weight per unit volume of the positive electrode is measured excluding the weight (amount) of the current collector.

The rechargeable lithium battery realizes a high weight per unit area of a positive electrode and/or a high plate density to meet the demand for a high-capacity battery. Generally, when the weight per unit area increases, an active mass becomes thick and when an electrode plate becomes thick, the conductive path between active materials becomes farther, which leads to decreased electrode plate conductivity. The decrease in the electrode plate conductivity results in deteriorated high rate characteristic and cycle-life.

A conductive material of a non-fiber shaped material and a conductive material of a fiber shaped material are mixed and used in order to improve the electrode plate conductivity having a high weight per unit area and/or a plate density.

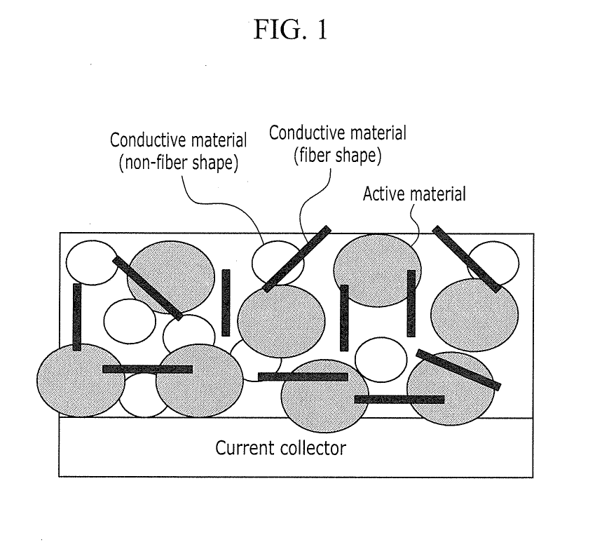

When the thickness of a plate is relatively thin, there is no problem with the conductivity although an amorphous conductive material is used alone. However, as the plate grows thick, the possibility that the amorphous conductive material with form a conductive path is decreased. Herein, when a conductive material using a fiber shaped material is used, the conductive path between the active materials is elongated so as to improve the electrode plate conductivity. This may be understood with reference to FIG. 1, which is a cross-sectional view illustrating a positive electrode including a fiber shaped material and a non-fiber shaped material as conductive materials in a rechargeable lithium battery, in accordance with an embodiment of the present invention.

However, when a conductive material includes only a fiber shaped material, a greater amount of the fiber shaped material than that of an active material has to be used as the conductive material in order to acquire a desired electrode plate conductivity because the fiber shaped material has a small specific surface area, and this may cause a problem of decreased battery capacity. Therefore, the rechargeable lithium battery includes a mixture of a fiber shaped material and a non-fiber shaped material as a conductive material.

Rechargeable lithium batteries may be classified into lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. Structures and fabrication methods for lithium ion batteries are known in the art.

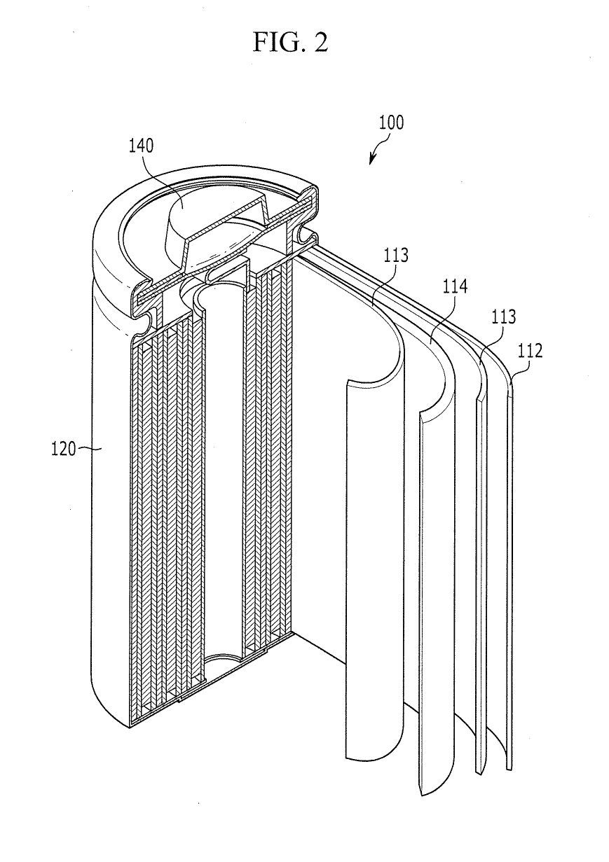

FIG. 2 is an exploded perspective view of a rechargeable lithium battery in accordance with an embodiment of the present invention. Referring to FIG. 2, the rechargeable lithium battery 100 is formed with a cylindrical shape and includes a negative electrode 112, a positive electrode 114, a separator 113 disposed between the a positive electrode 114 and negative electrode 112, an electrolyte impregnated in the negative electrode 112, the positive electrode 114, and the separator 113, a battery case 120, and a sealing member 140 sealing the battery case 120. The rechargeable lithium battery 100 is fabricated by sequentially stacking the negative electrode 112, the positive electrode 114, and the separator 113, and spiral-winding them and housing the wound product in the battery case 120.

The negative electrode includes a current collector and a negative active material layer formed over the current collector, and the negative active material layer includes a silicon-based negative active material.

Non-limiting examples of the silicon-based negative active material include silicon (Si), silicon oxide, silicon oxide coated with a conductive carbon, silicon (Si) coated with a conductive carbon, and combinations thereof.

The negative active material layer may include a binder, and a conductive material may optionally also be added.

The binder improves binding properties of the negative active material particles to each other and to a current collector. Examples of the binder include at least one selected from the group consisting of polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon and the like, but are not limited thereto.

Any electrically conductive material may be used as the conductive material unless it causes a chemical change. Examples of the conductive material include: carbon-based materials such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; and mixtures thereof.

The current collector may be selected from the group consisting of a copper foil, a nickel foil, a stainless steel foil, a titanium foil, a nickel foam, a copper foam, a polymer substrate coated with a conductive metal, and combinations thereof.

The positive electrode includes a current collector and a positive active material layer disposed on the current collector. The positive active material layer may be formed on one side or both sides of the current collector.

The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used:

LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c}D_{c} (wherein, in the above formula, 0≦b≦0.5 and 0≦c≦0.05); LiₐNi_{1-b-c}Co_{b}R_{c}D_{c} (wherein, in the above formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}D_{α} (wherein, in the above formula, 0.90≦a≦1.8, 0≦b≦0.5, 0≦c≦0.05 and 0<α≦2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Mn_{b}R_{c}O_{2-α}Z₂ (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is selected from Ni, Co, Mn, and combinations thereof; R is selected from Al, Ni, Co, Mn, Cr, Fe, Mg, Sr, V, rare earth elements, and combinations thereof; D is selected from O, F, S, P, and combinations thereof; E is selected from Co, Mn, and combinations thereof; Z is selected from F, S, P, and combinations thereof; G is selected from Al, Cr, Mn, Fe, Mg, La, Ce, Sr, V, and combinations thereof; Q is selected from Ti, Mo, Mn, and combinations thereof; T is selected from Cr, V, Fe, Sc, Y, and combinations thereof; and J is selected from V, Cr, Mn, Co, Ni, Cu and combinations thereof.

The compound can have a coating layer on the surface, or can be mixed with a compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxylcarbonate of a coating element. The compounds for a coating layer can be amorphous or crystalline. The coating element for a coating layer may include one of Mg, Al, Co, K, Na, Ca, Si, Ti, V, Sn, Ge, Ga, B, As, Zr, and a mixture thereof. The coating layer can be formed in a method having no negative influence on properties of a positive active material by including these elements in the compound. For example, the method may include any coating method such as spray coating, dipping, and the like, but is not illustrated in more detail, since it is well-known to those who work in the related field.

The positive active material layer may include a binder, and a conductive material may also be added.

The binder improves binding properties of the positive active material particles to each other and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used in order to improve conductivity of an electrode, and includes a fiber shaped material and a non-fiber shaped material.

The fiber shaped material has a fiber shape. The diameter of the fiber shape may range from about 0.01 μm to about 100 μm, and the length may range from about 1 μm to about 100 μm. For example, a fiber shaped material having a length of about 1 μm to about 50 μl or about 5 μm to about 20 μm may be used.

Non-limiting examples of the fiber shaped material include vapor grown carbon fiber (VGCF), carbon nano-tube, carbon nano-fiber, metal fiber, and combinations thereof. Non-limiting examples of the metal fiber include fiber shaped Ni.

The conductive material may include the non-fiber shaped material and the fiber shaped material at a weight ratio of about 0.6 to about 3. As described above, the electrode plate conductivity may be improved by mixing a fiber shaped material with a non-fiber shaped material and using the mixture as a conductive material, but the use of an excessive amount of the fiber shaped material decreases the battery capacity. Thus, when the content ratio falls in the above range, it is desirable in terms of the electrode plate conductivity and the battery capacity. Also, when fiber shaped material is used too much as a conductive material, the electrode plate may not realize a desired level of active mass density. Here, the fiber shape of the fiber shaped material may be broken. Therefore, the above-mentioned ratio exists as the desired (e.g., critical) mixing ratio of the fiber shaped material and the non-fiber shaped material.

The non-fiber shaped material may not be of a fiber shape, but of a plate shape, a bead shape, a flake shape, or a combination thereof.

The weight ratio of the amount of a positive active material to the conductive material may range from about 97:3 to about 99:1.

The non-fiber shaped material may be any electronically conductive material that does not cause a chemical change in a battery. Non-limiting examples of the non-fiber shaped material includes natural graphite, artificial graphite, carbon black, acetylene black, ketjen black, carbonfiber, metal powder such as copper, nickel, aluminum, and silver, and metal fiber, and one or more conductive materials such as polyphenylene derivative.

The current collector may be Al, but is not limited thereto.

The negative and positive electrodes may be fabricated by a method including mixing the active material, a conductive material, and a binder into an active material composition, and coating the composition on a current collector, respectively. The electrode manufacturing method is known, and thus is not described in detail in the present specification. The solvent includes N-methylpyrrolidone and the like, but is not limited thereto.

The above-described positive active material layer may be prepared by coating a current collector with an active material composition containing a positive active material, a conductive material, a binder, a solvent, drying the coated current collector, and compressing it. The prepared current collector and the positive active material layer may be collectively referred to as a positive active composite.

When the positive active composite is prepared as described above, the coating amount of the active material composition containing a positive active material, a conductive material, a binder, a solvent is controlled to adjust the thickness of the positive active material layer. Resultantly, the overall thickness of a positive electrode is adjusted by controlling the thickness of the positive active material layer.

When a rechargeable lithium battery with high-capacity cells is fabricated, a greater weight per unit area of a positive electrode (or positive active composite) is required.

To realize high-capacity cells, the rechargeable lithium battery has a weight per unit area (or loading level: LL; current collector excluded) of a positive electrode (or positive electrode plate) in a range from about 20 mg/cm² to about 100 mg/cm². As mentioned above, the weight per unit area (or loading level: LL; current collector excluded) of a positive electrode (or positive electrode plate) in such a numerical range can be accomplished by forming the positive active material layer on one side or forming the positive active material layers on both sides of the current collector. Here, the weight per unit area (or loading level: LL; current collector excluded) of a positive electrode (or positive electrode plate) having both side positive active material coated current collector electrode plate may become doubled compared to the that of a positive electrode having only one side positive active material coated current collector (e.g., with only a single positive active material layer).

According to another embodiment, the rechargeable lithium battery has a plate density of a positive electrode, which is a weight per unit volume of a positive electrode, in a range from about 3.0 g/cc to about 4.1 g/cc (cm³) to realize high-capacity cells. Having the active mass density of the above range is desired in terms of energy density.

The positive electrode plate may be prepared by controlling the thickness of the positive active material layer to have the loading level or active mass density of the above range, or the weight per unit volume of the above range. For example, the total thickness of the positive electrode plate including the positive active material layer and the current collector may range from about 10 μm to about 300 μm. Here, the positive active material layer may be formed on one side or both sides of the current collector.

Generally, when the thickness of an electrode plate is thicker, the electrical resistance is increased and the conductivity is decreased. However, the conductivity of the positive electrode may be maintained at an excellent level by using a conductive agent of the fiber shaped material included in the positive active material layer.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like. Examples of the ester-based solvent may include methyl acetate, ethyl acetate, n-propyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like. Examples of the ketone-based solvent include cyclohexanone, and the like. Examples of the alcohol-based solvent include ethyl alcohol, isopropyl alcohol, and the like. Examples of the aprotic solvent include nitriles such as R—CN (wherein R is a C2 to C20 linear, branched, or cyclic hydrocarbon group including a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent is prepared by mixing a cyclic carbonate and a linear carbonate. The cyclic carbonate and the linear carbonate are mixed together in the volume ratio of about 1:1 to about 1:9. Within this range, performance of electrolyte may be improved.

In addition, the non-aqueous organic electrolyte may be further prepared by mixing a carbonate-based solvent with an aromatic hydrocarbon-based solvent. The carbonate-based and the aromatic hydrocarbon-based solvents may be mixed together in a volume ratio ranging from about 1:1 to about 30:1.

The aromatic hydrocarbon-based organic solvent may be represented by the following Chemical Formula 1.

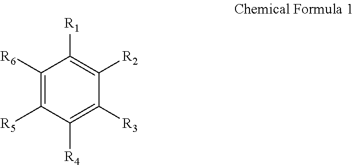

In Chemical Formula 1, R₁ to R₆ are each independently selected from the group consisting of hydrogen, halogen, a C1 to C10 alkyl group, a C1 to C10 haloalkyl group, and combinations thereof.

The aromatic hydrocarbon-based organic solvent may include fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate, an ethylene carbonate-based compound represented by the following Chemical Formula 2, or a combination thereof to improve cycle-life as an additive.

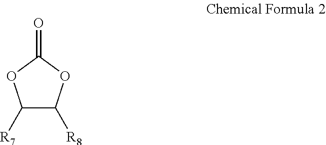

In Chemical Formula 2, R₇ and R₈ are each independently selected from hydrogen, hydrogen, a halogen, a cyano group (CN), a nitro group (NO₂), and a C1 to C5 fluoroalkyl group, provided that at least one of R₇ and R₈ is selected from a halogen, a cyano group (CN), a nitro group (NO₂), and a C1 to C5 fluoroalkyl group.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used to improve cycle life may be adjusted within an appropriate range.

The lithium salt is dissolved in an organic solvent and is utilized to supply lithium ions in a battery, to operate a basic operation of the rechargeable lithium battery, and to improve lithium ion transportation between positive and negative electrodes therein. Examples of the lithium salt include at least one supporting salt selected from LiPF₆, LiBF₄, LiSbF₆, LiAsF₆, LiC₄F₉SO₃, LiClO₄, LiAlO₂, LiAlCl₄. LiN(CₓF₂ₓ₊₁SO₂)(C_{y}F_{2y+1}SO₂) (where x and y are natural numbers), LiCl, Lil, LiB(C₂O₄)₂ (lithium bis(oxalato) borate, LiBOB), and combinations thereof. The lithium salt may be used in a concentration ranging from about 0.1 M to about 2.0 M. In one embodiment, when the lithium salt is included at the above concentration range, an electrolyte has excellent performance and lithium ion mobility due to desired electrolyte conductivity and viscosity.

The rechargeable lithium battery may further include a separator between the negative electrode and the positive electrode, as needed. Examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, should not in any sense be interpreted as limiting the scope of the present invention.

### EXAMPLES

### Example 1

A slurry was prepared by mixing about 4.8 g of LiCoO₂ as a positive active material, 0.1 g of polyvinylidenefluoride (PVDF) as a binder, a mixture of about 0.025 g of vapor grown carbon fiber (VGCF) having a diameter of about 0.150 μm, and about 0.075 g of denka black as a conductive material in a solvent of NMP. One side of a 15 μm-thick aluminum current collector was coated with the slurry to have a loading level of about 20 mg/cm². A positive electrode plate was fabricated by drying the aluminum current collector coated with the slurry in an oven set to about 120° C., and compressing the electrode plate to a plate density of about 3.0 g/cc.

A coin half cell was fabricated by using metal Li as a negative electrode, including about 0.2 wt % of LiBF₄ and about 5 wt % of fluoroethylene carbonate (FEC) as an electrolyte solution, and using ethylenecarbonate (EC)/ethylmethylcarbonate (EMC)/diethylcarbonate (DEC) (at a weight ratio of about 3/2/5) containing LiPF₆ in a concentration of about 1.15M.

### Examples 2 to 16

One side of a 15 μm-thick aluminum current collector was coated with a slurry prepared according to the same method as Example 1 in each of Examples 2 to 16, except that the contents of VGCF and denka black as the conductive materials were changed as presented in the following Table 1 to have loading levels as presented in the following Table 1. Also, in each of Examples 2 to 16, a positive electrode plate was fabricated by drying the aluminum current collector coated with the slurry in an oven set to about 120° C., and compressing the electrode plate to a plate density as presented in the following Table 1.

### Example 17

A 18650 cylindrical full cell was fabricated according to the same method as Example 3, except that both sides of a 15 μm-thick aluminum current collector was coated with a slurry having the contents of VGCF and denka black as the conductive materials as presented in the following Table 1 to have a loading level of about 40 mg/cm² and that a positive electrode plate was fabricated by drying the aluminum current collector coated with the slurry in an oven set to about 120° C., and compressing the electrode plate to a plate density as presented in the following Table 1.

### Example 18

A 18650 cylindrical full cell was fabricated according to the same method as Example 7, except that both sides of a 15 μm-thick aluminum current collector was coated with a slurry having the contents of VGCF and denka black as the conductive materials as presented in the following Table 1 to have a loading level of about 50 mg/cm² and that a positive electrode plate was fabricated by drying the aluminum current collector coated with the slurry in an oven set to about 120° C., and compressing the electrode plate to a plate density as presented in the following Table 1.

### Example 19

A 18650 cylindrical full cell was fabricated according to the same method as Example 7, except that both sides of a 15 μm-thick aluminum current collector was coated with a slurry having the contents of VGCF and denka black as the conductive materials as presented in the following Table 1 to have a loading level of about 80 mg/cm² and that a positive electrode plate was fabricated by drying the aluminum current collector coated with the slurry in an oven set to about 120° C., and compressing the electrode plate to a plate density as presented in the following Table 1.

### Example 20

A 18650 cylindrical full cell was fabricated according to the same method as Example 7, except that both sides of a 15 μm-thick aluminum current collector was coated with a slurry having the contents of VGCF and denka black as the conductive materials as presented in the following Table 1 to have a loading level of about 100 mg/cm² and that a positive electrode plate was fabricated by drying the aluminum current collector coated with the slurry in an oven set to about 120° C., and compressing the electrode plate to a plate density as presented in the following Table 1.

### Comparative Examples 1 to 10

Coin half cells were each fabricated according to the same method as Example 1, except that the contents of VGCF and denka black, loading levels and plate densities among the conductive materials included in the positive active materials were changed as presented in the following Table 1.

TABLE 1

| | Conductive material (Trade name) | | | | | |
|---|---|---|---|---|---|---|
| | | | Weight ratio of | Positive | Weight per | |
| | | | non-fiber | active | unit area of | Plate density |
| | Non-fiber | Fiber | shaped material/ | material + | positive | of positive |
| | shaped material | shaped material | fiber shaped | PVDFbinder | electrode | electrode |
| | (denka black) wt % | (VGCF) wt % | material | wt % | mg/cm² | g/cm³ |
| Comp. Ex. 1 | 2 | 0 | — | 96 + 2 | 18 | 3.0 |
| Comp. Ex. 2 | 2 | 0 | — | 96 + 2 | 20 | 3.0 |
| Comp. Ex. 3 | 2 | 0 | — | 96 + 2 | 25 | 3.0 |
| Comp. Ex. 4 | 0 | 2 | — | 96 + 2 | 25 | 3.0 |
| Comp. Ex. 5 | 0 | 2 | — | 96 + 2 | 25 | 3.5 |
| Comp. Ex. 6 | 0 | 2 | — | 96 + 2 | 25 | 4.0 |
| Comp. Ex. 7 | 1.5 | 0.5 | 3 | 96 + 2 | 18 | 3.0 |
| Comp. Ex. 8 | 1.25 | 0.75 | 1.7 | 96 + 2 | 18 | 3.0 |
| Comp. Ex. 9 | 1.0 | 1.0 | 1 | 96 + 2 | 18 | 3.2 |
| Comp. Ex. 10 | 0.75 | 1.25 | 0.6 | 96 + 2 | 18 | 3.2 |
| Ex. 1 | 1.5 | 0.5 | 3 | 96 + 2 | 20 | 3.0 |
| Ex. 2 | 1.25 | 0.75 | 1.7 | 96 + 2 | 20 | 3.0 |
| Ex. 3 | 1.0 | 1.0 | 1 | 96 + 2 | 20 | 3.0 |
| Ex. 4 | 0.75 | 1.25 | 0.6 | 96 + 2 | 20 | 3.0 |
| Ex. 5 | 1.5 | 0.5 | 3 | 96 + 2 | 25 | 3.5 |
| Ex. 6 | 1.25 | 0.75 | 1.7 | 96 + 2 | 25 | 3.5 |
| Ex. 7 | 1.0 | 1.0 | 1 | 96 + 2 | 25 | 3.5 |
| Ex. 8 | 0.75 | 1.25 | 0.6 | 96 + 2 | 25 | 3.5 |
| Ex. 9 | 1.5 | 0.5 | 3 | 96 + 2 | 40 | 4.0 |
| Ex. 10 | 1.25 | 0.75 | 1.7 | 96 + 2 | 40 | 4.0 |
| Ex. 11 | 1.0 | 1.0 | 1 | 96 + 2 | 40 | 4.0 |
| Ex. 12 | 0.75 | 1.25 | 0.6 | 96 + 2 | 40 | 4.0 |
| Ex. 13 | 1.5 | 0.5 | 3 | 96 + 2 | 50 | 3.5 |
| Ex. 14 | 1.25 | 0.75 | 1.7 | 96 + 2 | 50 | 3.5 |
| Ex. 15 | 1.0 | 1.0 | 1 | 96 + 2 | 50 | 3.5 |
| Ex. 16 | 0.75 | 1.25 | 0.6 | 96 + 2 | 50 | 3.5 |
| Ex. 17 | 1.0 | 1.0 | 1 | 96 + 2 | 40 | 3.0 |
| Ex. 18 | 1.0 | 1.0 | 1 | 96 + 2 | 20 | 3.5 |
| Ex. 19 | 1.0 | 1.0 | 1 | 96 + 2 | 80 | 4.0 |
| Ex. 20 | 1.0 | 1.0 | 1 | 96 + 2 | 100 | 3.5 |

### Experimental Example 1

The high rate characteristics (e.g., high rate discharge characteristics) and 0.5 C charge and discharge cycle-life characteristics of the rechargeable lithium battery cells fabricated according to Examples 1 to 16 and Comp. Ex. 1 to 10 were evaluated.

The high rate characteristics were evaluated by calculating a≦1.0 C discharge capacity ratio based on a 0.2 C discharge capacity taken as 100%. The high rate characteristics results were presented in the following Table 2 by performing the same experiments onto the same 5 battery cells and obtaining an average value thereof.

The cycle-life characteristics were evaluated by performing a cycle of charging at about 0.5 C until about 4.4V and discharging at about 0.5 C until about 3.0V about 100 times, measuring the capacities at the 100^{th} cycle, and calculating the capacity retention at the 100^{th} cycle based on the initial capacity in percentage (%). The results were as shown in the following Table 2.

TABLE 2

| | High rate | 0.5 C charge and discharge |
|---|---|---|
| | characteristic | cycle-life |
| | 1 C capacity | capacity retention at 100th cycle |
| | relative 0.2 C | relative to initial cycle capacity |
| | capacity (%) | (%) |
| Comp. Ex. 1 | 85% | 88% |
| Comp. Ex. 2 | 80% | 82% |
| Comp. Ex. 3 | 72% | 75% |
| Comp. Ex. 4 | 77% | 63% |
| Comp. Ex. 5 | 50% | 53% |
| Comp. Ex. 6 | 46% | 45% |
| Comp. Ex. 7 | 85% | 88% |
| Comp. Ex. 8 | 86% | 85% |
| Comp. Ex. 9 | 85% | 86% |
| Comp. Ex. 10 | 83% | 87% |
| Ex. 1 | 88% | 90% |
| Ex. 2 | 92% | 91% |
| Ex. 3 | 91% | 93% |
| Ex. 4 | 92% | 93% |
| Ex. 5 | 92% | 93% |
| Ex. 6 | 93% | 92% |
| Ex. 7 | 92% | 93% |
| Ex. 8 | 92% | 93% |
| Ex. 9 | 87% | 91% |
| Ex. 10 | 92% | 93% |
| Ex. 11 | 86% | 93% |
| Ex. 12 | 93% | 88% |
| Ex. 13 | 91% | 89% |
| Ex. 14 | 87% | 87% |
| Ex. 15 | 92% | 93% |
| Ex. 16 | 87% | 88% |

Comparative Examples 1 to 3 used a non-fiber shaped material alone as a conductive material and differentiated the loading level at the same plate density. When the plate density was the same, the thickness of a positive electrode became thicker as the loading level became higher.

As shown in Comparative Examples 2 and 3, rather than Comparative Example 1, when the loading level was raised at the same plate density, the thickness of the electrode plate became thicker and accordingly, the electrode plate conductivity was decreased so as to deteriorate the high rate characteristic and cycle-life.

Comparative Examples 4 to 6 used conductive material of a fiber shaped material. Since the conductive material of a fiber shaped material has a small specific surface area, a desired electrode plate conductivity may not be achieved although the fiber shaped material is inputted in the same weight of the non-fiber shaped material. Therefore, the capacity of a battery cell is decreased, and high rate characteristic and cycle-life characteristic are deteriorated. Also, the thickness of an electrode plate may be decreased in order to increase the plate density at the same loading level, but the fiber shaped material is broken and thus a desired electrode plate conductivity is not achieved so as to decrease the performance of a battery cell.

In each of Comparative Examples 7 to 10, the conductive material of a non-fiber shaped material and the conductive material of a fiber shaped material were mixed at the ratios shown in Table 1 so as to fabricate electrode plates having a loading level of 18.

When the loading level ranges and the plate density ranges are lower than those of the exemplary embodiments, even though the conductive material of the fiber shaped material is not necessarily mixed, performance similar to that of a case where the conductive material of a non-fiber shaped material was used as illustrated in Comparative Example 1 were obtained.

In Examples 1 to 16, electrode plates of a high loading level and a high plate density range were fabricated by mixing a conductive material of a non-fiber shaped material and a conductive material of a fiber shaped material at the ratios shown in Table 1, and then a coin cell test was performed onto the electrode plates. As a result, a battery cell having an excellent high rate characteristic and an excellent cycle-life characteristic was fabricated.

In Examples 17 to 20, cylindrical full cells were fabricated, respectively under the same conditions of Examples 3, 7, 11 and 15 except that both sides of the corrent collector were coated with the positive active material layers, resulting in loading levels twice as much as those of Examples 3, 7, 11 and 15. Because a high rate characteristic and a cycle-life characteristic can be judged by observing the result of the coin half cell test, an excellent high rate characteristic and an excellent cycle-life characteristic for Examples 17 to 20≦can be expected as from the corresponding coin half cell results of Examples 3, 7, 11 and 15.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of Symbols

| | |
|---|---|
| 100: rechargeable lithium battery | 112: negative electrode |
| 113: separator | 114: positive electrode |
| 120: battery case | 140: sealing member |

What is claimed is:

1. A rechargeable lithium battery, comprising:
a negative electrode comprising a silicon-based negative active material;
a positive electrode comprising a positive active material capable of intercalating and deintercalating lithium, and a conductive material comprising a fiber shaped material and a non-fiber shaped material, wherein a weight per unit area of the positive electrode is about 20 mg/cm² to about 100 mg/cm²; and
a non-aqueous electrolyte.

2. The rechargeable lithium battery of claim 1, wherein a plate density of the positive electrode is about 3.0 g/cc to about 4.1 g/cc.

3. The rechargeable lithium battery of claim 1, wherein the conductive material comprises the non-fiber shaped material and the fiber shaped material at a weight ratio of about 0.6 to about 3.

4. The rechargeable lithium battery of claim 1, wherein the weight ratio of the positive active material and the conductive material is about 97:3 to about 99:1.

5. The rechargeable lithium battery of claim 1, wherein the positive electrode is a positive electrode plate comprising a current collector and a layer including the positive active material and the conductive material formed over the current collector.

6. The rechargeable lithium battery of claim 5, wherein the layer including the positive active material and the conductive material further comprises a binder.

7. The rechargeable lithium battery of claim 6, wherein the binder comprises at least one selected from the group consisting of polyvinylalcohol, carboxylmethylcellulose, hydroxypropylcellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon.

8. The rechargeable lithium battery of claim 1, wherein the total thickness of the positive electrode is about 10 μm to about 300 μm.

9. The rechargeable lithium battery of claim 1, wherein the diameter of the fiber shaped material is about 0.01 μm to about 100 μm, and the length is about 1 μm to about 100 μm.

10. The rechargeable lithium battery of claim 1, wherein the fiber shaped material comprises at least one selected from the group consisting of a vapor grown carbon fiber (VGCF), a carbon nano-tube, a carbon nano-fiber, and a metal fiber.

11. The rechargeable lithium battery of claim 1, wherein the non-fiber shaped material comprises at least one selected from the group consisting of natural graphite, artificial graphite, carbon black, acetylene black, ketjen black, copper, nickel, aluminum, silver, and polyphenylene.

12. The rechargeable lithium battery of claim 1, wherein the non-fiber shaped material comprises at least one shape selected from the group consisting of plate shape, bead shape, and flake shape.

13. The rechargeable lithium battery of claim 1, wherein the silicon-based negative active material comprises at least one selected from the group consisting of silicon (Si), silicon oxide, silicon oxide coated with conductive carbon, and silicon (Si) coated with conductive carbon.

14. The rechargeable lithium battery of claim 1, wherein the positive active material is selected from LiₐA_{1-b}R_{b}D₂ (wherein, in the above formula, 0.90≦a≦1.8 and 0≦b≦0.5); LiₐE_{1-b}R_{b}O_{2-c}D_{b} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5 and 0≦c≦0.05); LiₐE_{1-b-b-c}Co_{b}R_{c}D_{α} (wherein, in the above formula, 0.90≦a≦1.8, 0≦b≦0.5, 0≦c≦0.05 and 0<α≦2); LiₐNi_{1-b-b}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}CO_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}D_{α} (wherein, in the above formula, 0.90≦a≦1.8, 0≦b≦0.5, 0≦c≦0.05 and 0<α≦2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Mn_{b}R_{c}O_{2-α}Z₂ (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001 d≦0.1); LiₐNi_{b}Co_{c}Mn_{d}GₑO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃(0≦f≦2); Li_{(3-f)}Fe₂(PO₄)₃(0≦f≦2); LiFePO₄, and combinations thereof, wherein
A is selected from Ni, Co, Mn, and combinations thereof; R is selected from Al, Ni, Co, Mn, Cr, Fe, Mg, Sr, V, a rare earth element, and combinations thereof; D is selected from O, F, S, P, and combinations thereof; E is selected from Co, Mn, and combinations thereof; Z is selected from F, S, P, and combinations thereof; G is selected from Al, Cr, Mn, Fe, Mg, La, Ce, Sr, V, and combinations thereof; Q is selected from Ti, Mo, Mn, and combinations thereof; T is selected from Cr, V, Fe, Sc, Y, and combinations thereof; and J is selected from V, Cr, Mn, Co, Ni, Cu and combinations thereof.

15. The rechargeable lithium battery of claim 1, wherein the positive electrode comprises an Al current collector.

16. A rechargeable lithium battery, comprising:
a negative electrode comprising a silicon-based negative active material;
a positive electrode comprising a positive active material capable of intercalating and deintercalating lithium, and a conductive material comprising a fiber shaped material and a non-fiber shaped material; and
a non-aqueous electrolyte,
wherein a plate density of the positive electrode is about 3.0 g/cc to about 4.1 g/cc.
